(19) United States
(12) Patent Application Publication
(10) Pub. No.: US 2005/0045063 A1
(43) Pub. Date: Mar. 3, 2005

(54) Marking solution for counterfeit-resistant identification of a valuable object, marking produced by the marking solution and method for marking a valuable object

(76) Inventors: Matthias Niggemann, Berlin (DE); Manfred Paeschke, Basdorf (DE); Armin Franz-Burgholz, Falkensee (DE); Oliver Muth, Berlin (DE); Georg Bauer, Nuernberg (DE); Bjoern Grassl, Nuernberg (DE); Wolfgang Spickermann, Quirnbach (DE); Andre Josten, Hemhofen (DE); Harald Walter, Erlangen (DE); Joerg Hassmann, Erlangen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/494,415

(22) PCT Filed: Nov. 1, 2002
(86) PCT No.: PCT/EP02/12226

(30) Foreign Application Priority Data
Nov. 2, 2001 (DE) 101 53 596.1

(51) Int. Cl. B05D 1/28; C09D 11/00

(52) U.S. Cl. 106/31.43; 427/429; 427/428.01; 106/31.75; 106/31.58; 106/31.86; 118/46

(57) ABSTRACT

The present invention provides a marking solution that is to a certain extent counterfeit-resistant, that is particularly easy to use, that can be stamped and that can be used for performing day-to-day markings, especially for the identification of documents, and that is suitable for comparatively simple identification. The marking solution includes an aqueous solution with single-stranded nucleic acids or derivatives thereof, in addition to glycerin and polyethylene glycol (PEG).

The invention relates to a marking solution for counterfeit-resistant marking of a valuable object, especially a document. The invention also relates to a marking produced with the marking solution as well as to a method for marking a valuable object.

Counterfeit-resistant marking can be particularly significant for numerous valuable objects in order to ensure the authenticity of these objects. This especially applies to valuable and/or security-related documents such as, for example, bank notes, identification papers and the like, but also to packaging for sensitive objects such as, for instance, medical drugs.

Such markings can be made on the basis of nucleic acids whereby the authenticity of the marking can be checked by using nucleic acid sequences that are complementary to the marking nucleic acid sequence in combination with a test substance that can be activated by a reaction of the marking nucleic acid sequence with its complementary sequences.

German application DE 197 38 816 A1 discloses the use of nucleic acids bound to a solid for marking purposes. For the identification, however, the nucleic acids have to be removed from the solid by means of an extraction procedure. The nucleic acids present in the solution then have to be replicated by means of a specific reaction such as a polymerase chain reaction (PCR). In the subsequent steps, the replicated nucleic acid sequence is analyzed. This is a time-consuming and labor-intensive procedure that is not suitable for on-site verification of authenticity. Moreover, the extraction of the nucleic acids applied for marking purposes is not possible or desired with every solid.

Another method for identifying a marking provided on a solid object is known from German application DE 198 11 730 A1. This marking has a nucleotide sequence in which a first end is covalently bound to the solid object via spacer molecules while a second end is bound to a magnetic means. The production of modified oligo nucleotides entails considerable effort. The nucleotide sequence of the marking is brought into contact with a corresponding nucleotide sequence of a detection means that is bound to the solid object. However, the marking molecules that are affixed to the solid object and that form a marking layer with only a limited thickness for accepting the active marking molecules are not stable against mechanical stress and are susceptible to dirt, which can cause the marking to lose stability. Moreover, this demanding method is only suitable for flat surfaces that allow close contact between the marking and the detection means.

U.S. Pat. No. 5,139,812 discloses the use of an ink containing a prescribed nucleic acid for the counterfeit-resistant marking of objects. The marking is applied to a secret place on a valuable object. In order to mark a plurality of objects in such a way that they can be distinguished from each other, different writing is applied onto them with ink. Marking applied in such a manner is identified by binding another nucleic acid to the existing nucleic acid. The bound nucleic acid can be rendered visible by means of a color reaction or on the basis of radioactive marking. With this approach, the marking has to be verified by means of a multistage and correspondingly demanding procedure. Consequently, this method is not suitable for day-to-day use.

European patent application EP 0,745,690 A2 describes so-called molecular beacons and their use for hybridization. Employing them for the detection of markings is not disclosed in this document.

U.S. Pat. No. 5,866,336 describes primers marked with a fluorophore. The primers are amplified by means of a polymerase chain reaction (PCR). Unfolding of the primers is triggered in the hybridized state. This causes the fluorescence behavior of the fluorophore provided on the primer to change. This prior-art method is not suitable for a quick identification of a marking because it requires the costly and time-consuming polymerase chain reaction (PCR).

All of the above-mentioned approaches have in common that the use of nucleic acid sequences as the marking carriers can fundamentally ensure a high security potential and especially a high degree of counterfeit resistance. However, the use of these marking carriers for securing objects that are relevant on a daily basis and/or for carrying out a quick, inexpensive and uncomplicated on-site identification of the marking, for example, at official agencies or pharmacies, is not a possibility, particularly in view of the equipment needed for verifying the authenticity. This applies especially to the counterfeit-resistant marking of documents for which special care is required in checking the authenticity because of the paper material commonly used for such documents.

Consequently, the invention is based on the objective of proposing a marking solution on the basis of nucleic acid sequences as the marking carrier, said solution being especially easy to employ and thus particularly suitable for use with routine marking, especially the marking of documents, and it is also well-suited for a relatively simple identification. Furthermore, a method for the counterfeit-resistant marking of objects that is particularly suitable for day-to-day use will likewise be put forward.

Regarding the marking solution, this objective is achieved in that the solution comprises, as its components, an aqueous solution with single-stranded nucleic acids or their derivatives as well as glycerin and polyethylene glycol (PEG).

In this context, the invention is based on the consideration that the marking solution should provide a particularly high level of counterfeit resistance, even for the envisaged everyday use. For this purpose, the marking solution is to be rendered suitable for rugged everyday use while retaining the nucleic acid sequence as the marking carrier. The handling of such a marking carrier in everyday use can be greatly simplified in that the marking solution is suitable for application by means of a high-pressure process, especially by stamping.

In order to make this possible, the nucleic acids intended as marking carriers are systematically combined with added materials that allow the marking solution to be used as a stamping ink. Here, the employed single-stranded nucleic acids or their derivatives are produced relatively simply and inexpensively without modifications. The components intended as added materials, namely, glycerin and polyethylene glycol (PEG), are relatively easily available and particularly compatible with each other as well as with nucleic acids. In this context, the glycerin functions as a hygroscopic substance and it keeps the aqueous fraction in the marking solution constant, even when stored for a prolonged time in the ambient atmosphere. Moreover, it can serve as a bonding agent while the polyethylene glycol (PEG) allows uniform application and adhesion of the marking solution onto an object to be marked in that it ensures sufficient viscosity of the marking solution and acts as a detergent.

Particularly reliable protection against counterfeiting and copying can be achieved in that the marking solution, in addition to the actual marking carrier, also contains substances that are similar to it but that are not intended as marking carriers, and that, for the uninitiated, are indistinguishable from the marking carrier. Consequently, during a counterfeiting attempt, the counterfeiter cannot recognize which specific component of the marking has to be duplicated, so that, if all of the components present had to be duplicated, this would call for considerable effort. For this reason, the nucleic acids or their derivatives preferably comprise a first fraction intended as the marking carrier and another, second fraction. Here, the second fraction, serving as a background, can conceal the first fraction that is actually intended as the marking carrier.

For this purpose, the second fraction, which is not intended as the marking carrier, is preferably present in an excess in the marking solution. In order to attain a particularly high level of counterfeit resistance, the ratio of the first fraction to the second fraction is preferably 1:9 or higher.

In order to reliably verify the first fraction of the nucleic acids or their derivatives—which are intended as the marking carrier—through excitation by a light source so as to trigger a fluorescence reaction with their complementary sequences configured as so-called molecular beacons, the marking carrier should be present in the marking solution in a sufficiently high, suitably selected concentration. For this purpose, in a particularly advantageous manner, a concentration of the first fraction in the marking solution ranging from 50 ppm to 2000 ppm, preferably between 200 ppm and 300 ppm, has been selected. Infrared spectrometry or mass spectrometry, for instance, are advantageously employed to ascertain the ppm value.

Deoxyribonucleic acids (DNA) are employed as single-stranded nucleic acids.

In order to be particularly counterfeit-resistant and practical to handle, especially in terms of its consistency, the marking solution preferably comprises 30% to 50% of the aqueous solution with single-stranded nucleic acids or their derivatives and/or 20% to 40% glycerin and/or 10% to 40% polyethylene glycol (PEG).

Even though lithium chloride in a concentration of 0.1 to 3.0 M, sodium or potassium lactate (0.5% to 5%), propylene glycol (1% to 10%), hyaluronic acid (0.2% to 2%), magnesium chloride (2% to 20%) or sorbitol (1% to 10%) can all be employed as the hygroscopic component, they are not very compatible with the nucleic acids or their derivatives, in addition to which they cannot function as bonding agents.

A coloring component is advantageously employed in order to facilitate a precise positioning of the marking solution or to optionally serve merely for information purposes in addition to the security function. Due to their light and heat resistance as well as their chemical stability, pigments in a concentration of advantageously up to 20% are added to the marking solution for this purpose.

Regarding the marking, the above-mentioned objective is achieved in that the marking solution forms a marking layer having a thickness of 0.5 μm to 5 μm. The long-term stable, durable and abrasion-proof marking layer that can be obtained using the marking solution allows a quantitative verification of the marking carrier even after years, while also allowing a fast on-site identification of the marking, that is to say, for example, at official agencies, with relatively simple, uncomplicated and rugged equipment, for instance, appropriate handheld readers.

In another embodiment, the marking layer is preferably applied in a predefined geometric arrangement onto an object to be marked. This geometric arrangement can be a predefined pattern, for example, a barcode. If its size is sufficient, such a pattern can be checked for authenticity multiple times.

As protection against contamination, in a particularly advantageous embodiment, the marking layer is covered with a protective layer, at least partially. In order to allow, for instance, fluorescent-optical identification of the marking layer, the protective layer is preferably configured so as to be transparent.

Regarding the method for marking objects, the above-mentioned objective is achieved in that the marking solution is applied onto an object that is to be marked.

For marking that is especially easy to handle and that can thus be carried out by anyone, and also for achieving a reproducible application of the marking solution, the latter is preferably applied by means of a high-pressure process whereby, in a particularly advantageous embodiment, a stamp is employed. Precisely the selection of a stamp ensures a constant, uniform and specific concentration of the marking carrier when the marking solution is applied onto the object to be marked, in addition to which such a stamp can easily be employed in day-to-day tasks.

In order to improve the visual appearance, a stamp with a two-part stamp pad can be employed. Due to cost considerations, the part containing the marking carrier can be smaller than an image-forming part to which, for instance, pigments that bring about a red coloration have been added so that the eye of an observer perceives the imprint as being red. The image-forming part is preferably made in the colors green, blue or black. The marking solution can also be applied as a clear solution, which creates an invisible and thus secret stamp imprint. The marking can also be applied with mechanical stamping devices, usually of the inkjet type.

In a particularly advantageous embodiment, the marking solution is part of a marking kit. This kit preferably comprises a reservoir filled with the marking solution and an applicator that contains an identification solution adapted to the marking solution.

So that the identification solution can be applied simply and quickly, a pen is advantageously provided as the applicator. The tip of the pen is preferably made of an absorbent fiber material.

For a fast and simple on-site identification of the marking, it is advantageous to employ the detection of a fluorescence reaction that is triggered by bringing the marking solution into contact with the identification solution, followed by irradiation with light at a prescribed wavelength. In order to allow such a fluorescence reaction, the identification solution preferably comprises nucleic acids or their derivatives configured as so-called molecular beacons, which are configured so as to be at least partially complementary to the single-stranded nucleic acids or their derivatives that have been intended as the marking carriers.

In the molecular beacons, the 3′-ends and 5′-ends of the nucleic acids or their derivatives are modified with a fluorophore or with a fluorescent quencher molecule. The terminal nucleotide sequences are selected in such a way that they are complementary over a short area and form a double strand, while the sequence area in the middle of the oligonucleotide acquires a curve like a hairpin or a loop. Under normal conditions, the double strand is sufficiently stable to bring the terminal modifications in the immediate proximity. The consequently small distance between the fluorophore and the quencher allows a radiationless transition that extinguishes the fluorescence in accordance with the so-called Forster effect.

Such a molecule can serve to verify the nucleic acid sequence of the marking carrier. For this purpose, for example, a sequence area in the hairpin segment of the molecular beacon has been selected that is complementary to the sequence section of the marking carrier. The length of this interaction area should be sufficiently large that enough bonding energy can be released to open the short double strand in the molecular beacon. Under these conditions, the fluorophore and the quencher become physically separated since now they are at the opposite ends of the new, more stable double strand. As a direct result, the fluorescence now is no longer extinguished and, after being appropriately excited, can serve as verification of the interaction with the nucleic acid sequence of the marking carrier.

In another advantageous embodiment, the marking kit has a stamp that can be filled with the marking solution. This stamp ensures a reproducible application of the marking solution onto the object to be marked, at a constant, uniform and specific concentration of the marking carrier.

The marking solution can be advantageously employed in all realms involving authentication and document protection. For this reason, the marking solution is preferably used to mark valuable and/or security-related documents such as, for instance, an identity card, a bank note or medical drug packaging.

The advantages attained with the invention consist primarily in the fact that the marking solution on the basis of single-stranded nucleic acids or their derivatives is counterfeit-resistant and, due to the added materials glycerin and polyethylene glycol (PEG), it is particularly well-suited for a uniform and durable application by means of a stamp onto an object to be marked, especially a valuable and/or security-related document that is relevant on a daily basis. It is precisely the 0.5 μm to 5 μm-thick marking layer formed by the stamp imprint with the marking solution and having a 9-fold excess of nucleic acids or their derivatives that are not intended as the marking carrier that ensures particularly reliable counterfeit resistance and copying protection, since the nucleic acids or their derivatives intended as the marking carriers cannot be found there by the uninitiated. Moreover, this long-term stable marking layer allows a quantitative confirmation of the marking carrier even after years, while also allowing a fast on-site fluorescent-optical identification of the marking, in other words, for example, at official agencies, employing devices that are relatively simple to operate.

An example of an embodiment of the invention will be explained in greater detail with reference to a drawing, which shows the following:

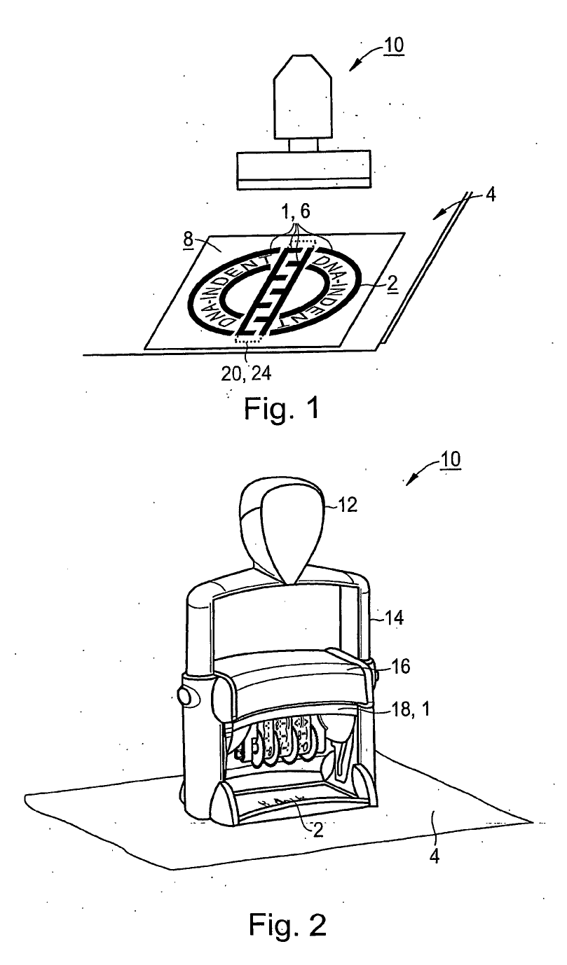

FIG. 1—a top view of a counterfeit-resistant marking;

FIG. 2—a side view of a stamp;

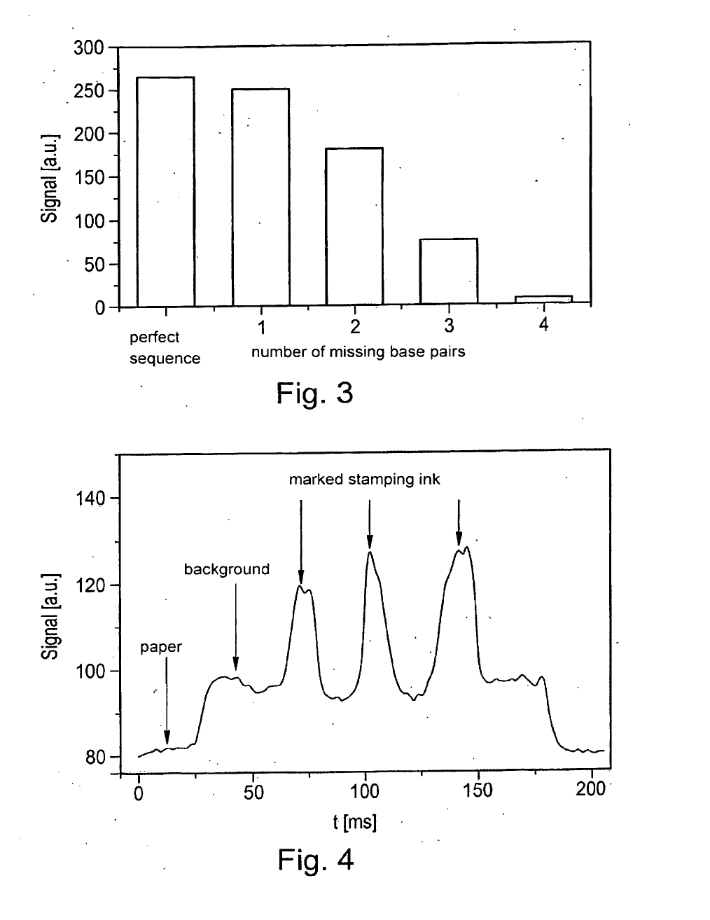

FIG. 3—the specificity of the signal as a function of the DNA sequence;

FIG. 4—the fluorescence signal of the marking, detected by means of a suitable handheld reader after application of the identification solution;

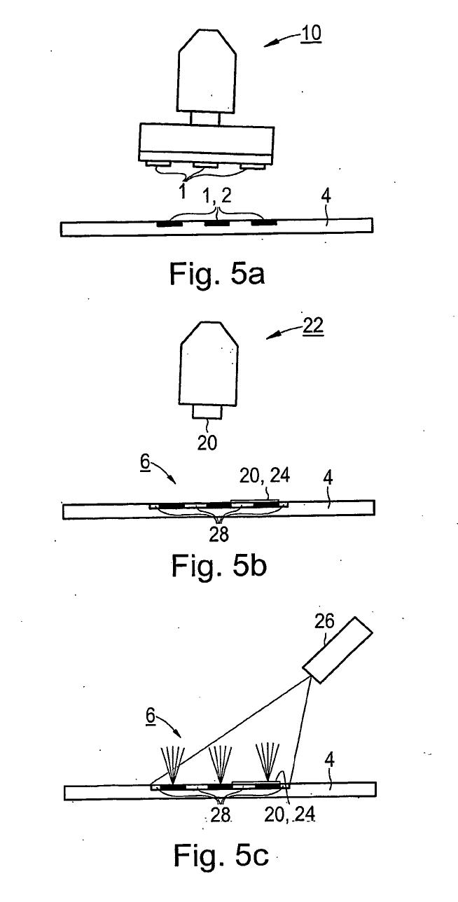

FIGS. 5a-5c—the process sequence in schematic cross-sectional views; and

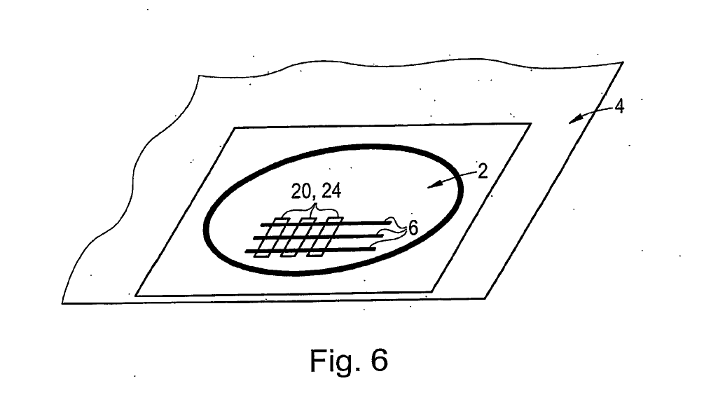

FIG. 6—schematically, an example of multiple readings of the marking.

The same parts are designated with the same reference numerals in all of the figures.

FIG. 1 shows a stamp imprint 2 created with a marking solution 1, said imprint having been applied onto an object 4, especially a valuable document, for example, a bank note. The stamp imprint 2 of the marking solution 1 forms a marking layer 6 on the surface of the object 4. The reference numeral 8 designates a transparent protective layer that covers the marking layer 6 and that serves as protection against contamination.

The provided marking solution 1 ensures a particularly high level of counterfeit resistance. For this purpose, as the foundation of the marking solution 1, nucleic acid sequences are employed for the marking carrier. Furthermore, handling in everyday use is considerably simplified in that the marking solution 1 in the form of stamping ink is suitable for application by means of a high-pressure method, especially by means of a stamp 10.

The embodiment employs a conventional manual stamp as the stamp 10 which, as shown in FIG. 2, has a fixed stamp pad 16 with a stamp plate 18 that receives the marking solution 1 and that is attached via a frame 14 arranged on a handle 12. By pressing the handle 12, the stamp plate 18 charged with marking solution 1 by the stamp pad 16 is rotated by 180° and moved towards the object 4 to be marked. Upon striking the object 4 to be marked, the stamp imprint 2 of the marking solution 1 is created. Naturally, it is also possible to use other commercially available stamps.

The marking solution 1 for counterfeit-resistant marking described in the embodiment is rendered particularly suitable for application by stamping. This is why materials are added to the marking solution 1 on the basis of 40% of an aqueous solution with single-stranded nucleic acids or their derivatives, especially deoxyribonucleic acids (DNA), since owing to their hygroscopic properties, these added materials compensate for evaporation of the aqueous fraction during prolonged storage in the ambient atmosphere and ensure reliable and uniform adhesion properties. For this purpose, the marking solution 1 in the embodiment contains 20% to 30% glycerin and 10% to 30% polyethylene glycol (PEG).

Moreover, pigments in a concentration of up to 10% are added to the marking solution 1, since said pigments, owing to their coloration, facilitate the application of the marking solution 1 onto the object 4 to be marked and also serve for information purposes.

The deoxyribonucleic acids (DNA) used in the embodiment comprise a first fraction intended as the marking carrier and another, second fraction that is similar to it but that is not intended as a marking carrier. This second fraction—which in the embodiment is added in a 9-fold excess—functions as a background, providing for enhanced counterfeit resistance in that the first fraction intended as the marking carrier—which in the embodiment is present in the marking solution 1 at a concentration ranging from 200 ppm to 300 ppm—can “hide” in the second fraction, which makes it hard for potential counterfeiters to find, and thus difficult to duplicate.

The marking solution 1 that in the embodiment has been applied by means of the stamp 10 onto the object 4 to be marked forms the marking layer 6 in a thickness of 1 μm to 2 μm. This long-term stable, durable and abrasion-proof marking layer 6 allows a quantitative verification of the marking carrier as well as a fast on-site identification of the marking still after years.

For purposes of identifying the marking, an identification solution 20 is applied by means of an applicator 22 (which has not been shown in greater detail in FIG. 1)—for instance, in the form of a stamp, dispenser, pen or another suitable means—onto the marking layer 6 in the area of an application surface 24 indicated by a broken line. The identification solution 20 comprises nucleic acids or their derivatives configured as molecular beacons, which are configured so as to be at least partially complementary to the DNA of the marking solution 1 intended as the marking carrier.

The molecular beacons can be provided with an NIR fluorophore or with a quencher suitable for this purpose on the 3′-ends and 5′-ends. Advantageously, Cy 5 (Amersham) is employed as the fluorophore and BHQ 3 (Biosearch Technologies Inc.) as the quencher. During the hybridization with the marking carrier, the change in the secondary structure of the molecular beacon occurs, as described in greater detail above. A fluorophore marking provided on the molecular beacon can be excited by means of an excitation light source 26, for instance, a laser diode. The fluorescent light emitted by the fluorophore can be detected with a photodiode. The occurrence of the characteristic fluorescent signal indicates the authenticity of the marking.

FIG. 3 shows a comparison of the strength of a fluorescent signal plotted on the y axis. The fluorescent signal is generated during the hybridization of the DNA—which is intended as the marking carrier—with the nucleic acids or their derivatives of the identification solution 20, which are intended as molecular beacons and which are at least partially complementary. The signals are shown minus the background of a hybridization with one molecular beacon, whereby either none or else one, two, three or four missing base pairs occur along the hybridized section. With the present method, a missing pair of two bases can already be distinguished. A missing pair of four bases leads to a drastically lower signal. This substantiates the high specificity of the identification method.

FIG. 4 depicts the signal of a stamp imprint 2 marked with DNA after application of the identification solution 20. Here, the identification solution 20 covers three consecutive fields of the first stamp imprint 2. The reading procedure was carried out with a handheld device—like a commercially available handheld scanner—that was moved above the stamp imprint 2. Signal maxima occur in the overlapping area of the stamp imprint 2 with the identification solution 20; all that is detected in the area in-between is background fluorescence as local minima. The quotients from the appertaining local maxima divided by the value of the background fluorescence only exhibit a slight fluctuation of 10% with respect to a mean value. Thus, it is ensured that the marking can be read out sequence-specifically.

FIGS. 5a to 5c schematically show cross-sectional views of an embodiment of the method for marking objects 4, for identifying the marking and for detection. By means of the stamp 10, a stamp imprint 2 is applied onto the object 4, especially a security-related document. The identification solution 20 is picked up with the applicator 22—which is a pen in the embodiment—in an amount of 1 μl. The identification solution 20 advantageously contains a molecular beacon in a Dig Easyhyb buffer (Roche, Biomedicals) at a concentration of 1 mmole/μl. A yellow colorant, for instance, food coloring E 104, can be added to the solution 20. The identification solution 20 can be applied with the applicator 22 onto the application surface 24 of the marking layer 6. The marking layer 6 is interrupted by reference surface areas 28. A fluorophore marking provided on the molecular beacon can be excited by means of the excitation light source 26, for example, a laser diode. The excitation light can be filtered with a conventional polymeric filter such as Roscolone 862—True Blue (Rosco). The fluorescent light emitted by the fluorophore due to the change in the secondary structure of the molecular beacon after the hybridization with the marking carrier can be detected with a photodiode. The occurrence of the characteristic fluorescence signal demonstrates the authenticity of the marking.

As can be seen in FIGS. 5a to 5c, the authenticity of the marking can be checked quickly and easily on-site. The checking procedure takes a mere 10 seconds. There is no need for a washing operation or for removing the marking from the marked object 4. The method being proposed as well as the counterfeit-resistant marking are very well-suited for marking mass-produced items, security-related documents and the like. They can be identified with an inexpensively manufactured handheld device.

FIG. 6 schematically shows a top view of an example of the multiple identification of a marking. In addition to other design features, a stamp imprint 2 has three parallel lines as the marking layer 6. The authenticity of the stamp imprint 2 is checked by means of the identification solution 20. In the embodiment, this identification solution 20 has been applied orthogonally to the three parallel lines onto the application surfaces 24 by means of the applicator 22 (not shown in FIG. 6). In this process, only a small part of the marking layer 6 is treated with the identification solution 20. The partial areas of the marking layer 6 that have not yet been treated with the identification solution 20 can be used for additional checks of the authenticity of the marking. This procedure is shown in FIG. 6, where the marking has been read three times. Preferably, the identification solution 20 is mixed with a dye so that the partial areas of the marking that have already been checked can be recognized.

List of reference numerals

| | |
|---|---|
| 1 | marking solution |
| 2 | stamp imprint |
| 4 | object |
| 6 | marking layer |
| 8 | protective layer |
| 10 | stamp |
| 12 | handle |
| 14 | frame |
| 16 | stamp pad |
| 18 | stamp plate |
| 20 | identification solution |
| 22 | applicator |
| 24 | application surface |
| 26 | excitation light source |
| 28 | reference surface |

1-19. (canceled)

20. A marking solution, comprising:
an aqueous solution including a plurality of single-stranded nucleic acid or derivatives thereof,
glycerin; and
polyethylene glycol (PEG).

21. The marking solution as recited in claim 20, wherein the single-stranded nucleic acids or their derivatives include a first fraction as a marking carrier and a second second fraction.

22. The marking solution as recited in claim 21, wherein a ratio of the first fraction to the second fraction is equal to or greater than 1:9.

23. The marking solution as recited in claim 21, wherein a concentration of the first fraction ranges from 50 ppm to 2000 ppm.

24. The marking solution as recited in claim 20, wherein the single-stranded nucleic acids include deoxyribonucleic acids (DNA).

25. The marking solution as recited in claim 20, wherein the aqueous solution makes up 30% to 50% of the marking solution.

26. The marking solution as recited in claim 20, wherein the glycerin makes up 20% to 40% of the marking solution.

27. The marking solution as recited in claim 20, wherein the polyethylene glycol makes up 10% to 40% of the marking solution.

28. The marking solution as recited in claim 20, further comprising a pigment in a concentration of up to 20%.

29. A marking on an object, the marking comprising:
a plurality of single-stranded nucleic acid or derivatives thereof, glycerin and polyethylene glycol (PEG); and
a layer thickness ranging from 0.5 μm to 5 μm.

30. The marking as recited in claim 29, further comprising a predefined geometric arrangement on the object.

31. The marking as recited in claim 29, further comprising a protective layer at least partially covering the layer thickness.

32. The marking as recited in claim 31, wherein the protective layer is configured so as to be transparent.

33. A method for marking an object, comprising:
providing a marking solution including an aqueous solution having a plurality of single-stranded nucleic acid or derivatives thereof, glycerin and polyethylene glycol (PEG); and
applying the marking solution to the object.

34. The method as recited in claim 33, wherein the applying is performed using a high-pressure technique.

35. The method as recited in claim 33, wherein applying is performed using a stamp.

36. The method as recited in claim 33, wherein the object is a valuable and/or security-related document.

37. The method as recited in claim 33, wherein the object is a medical drug packaging.

38. A marking kit comprising:
a reservoir holding a marking including an aqueous solution having a plurality of single-stranded nucleic acid or derivatives thereof, glycerin and polyethylene glycol (PEG); and
an applicator containing an identification solution adapted to the marking solution.

39. The marking kit as recited in claim 38, wherein the applicator includes a pen.

40. The marking kit as recited in claim 38, wherein at least a portion of the plurality of single-stranded nucleic acid or derivatives form marking carriers, and wherein the identification solution includes a second plurality of nucleic acids or their derivatives configured as molecular beacons formed so as to be at least partially complementary to the marking carriers.

41. The marking kit as recited in claim 38, wherein the reservoir includes a stamp.
